(19) United States
(12) Patent Application Publication
(10) Pub. No.: US 2002/0091571 A1
(43) Pub. Date: Jul. 11, 2002

(54) Methods and systems for electronic coupon issuance transmission and mangement

(76) Inventors: Nicholas A. Thomas, Orem, UT (US); Steven B. Smith, Holladay, UT (US)

Correspondence Address: Michael F. Krieger, KIRTON & McCONKIE, Suite 1800, 60 East South Temple, Salt Lake City, UT, 84111, US

(21) Appl. No.: 10/035,875

(22) Filed: Nov. 9, 2001

Related U.S. Application Data
(60) Provisional application No. 60/247,104, filed on Nov. 10, 2000.

(51) Int. Cl. G06F 17/60

(52) U.S. Cl. 705/14; 705/16; 705/26

(57) ABSTRACT

Methods and systems for electronic coupon issuance transmission and management. Wireless vendor devices and wireless purchaser devices transmit electronic coupons at a point of sale for coupon redemption. Further processing of the electronic coupon information may be performed with the purchaser device or with a secondary computing device after subsequent coupon transmission to that secondary device. The electronic coupons may incorporate a numerous variety of discount types as well as include various information such as purchaser profiles and coupon use histories. The electronic coupons may either be stored locally on the purchaser device or be a reference location on a network for the merchant to get coupon information from. The electronic coupons are also designed to allow the individual purchaser to automatically organize his or her coupons. Some electronic coupons can additionally be set to automatically delete upon expiration.

### RELATED APPLICATIONS

This application claims priority to U.S. Provisional Patent Application Serial No. 60/247,104, filed Nov. 10, 2000, entitled “METHODS AND SYSTEMS FOR ELECTRONIC COUPON ISSUANCE TRANSMISSION AND MANAGEMENT,” which is incorporated herein by reference.

### BACKGROUND OF THE INVENTION

1. Field of the Invention

The present invention relates to methods and systems for electronic coupon issuance transmission and management. In particular, the present invention relates to obtaining and/or utilizing an electronic coupon when purchasing a product and/or service in order to obtain the benefit of the electronic coupon and to the management of the electronic coupons utilized.

2. Background and Related Art

Electronic transactions involving the transfer of money and pecuniary assets are commonly performed. Goods and services are purchased “electronically” at stores and businesses over the telephone or via the Internet using credit or debit accounts with electronic authorization. Retail vendors typically accept credit and debit cards that are verified and authorized using traditional electronic communications methods. Currently, retail vendors typically accept some form of electronic payment as remuneration for goods and/or services.

Point-of-sale electronic payment devices are typically connected to the card issuers or their representatives, sometimes known as authorization processors (APs), through a conventional telephone line. Often a dedicated phone line is connected to the point-of-sale authorization device for quick access to authorization data.

Wireless communication technology has progressed rapidly in recent years. Cell phones and other long-range communication devices have proliferated and are now commonplace among consumers. As technology advances, the cost of these devices is plummeting and even more widespread use is imminent. Mobile phones, pagers, two-way radios, smartphones, personal digital assistants (PDAs), and other communicators are readily available to consumers.

Internet use is also skyrocketing with millions of new users logging on each year. In fact, Internet commerce now represents a significant portion of retail commerce and is used by millions of consumers each day.

Communications protocols exist that allow present generation electronic communications devices to interface with the Internet and access Internet resources. The Wireless Application Protocol (WAP) is an open, global specification that enables mobile wireless communications devices to access and interact with Internet information and services. WAP is a communications protocol and environment that may be built on nearly any operating system, including PalmOS, EPOC, Windows CE, FLEXOS, OS/9, JavaOS, and others and provides service interoperability between different device families. WAP typically works with most existing wireless communications networks such as CDPD, CDMA, GSM, PDC, PHS, TDMA, FLEX, ReFLEX, iDEN, TETRA, DECT, DataTAC, Mobitex, and others. WAP developers operate Internet gateways specifically tailored for wireless communications device users. These devices typically have small displays, limited memory, and less bandwidth than stationary, wire-connected computers. Therefore, WAP provides for the use of extensible markup languages (XMLs), such as the Wireless Markup Language (WML) that offers Internet content that is tailored for cell phones, PDAs, and other wireless portable communications devices.

Using WAP and similar technologies, vendors, news agencies, financial institutions, and other providers allow cell phone users and other portable communications device users to buy and sell securities, execute credit card transactions, make account transfers, make bill payments, receive and send e-mail, and view news reports. These providers offer seamless integration between the Internet and wireless portable communication devices.

Wireless communication devices are also becoming commonplace in the electronics industry. Wireless networking of portable computers and associated devices is beginning to replace a large segment of the networking market. Wireless communication devices, including wireless networking adapters, hubs, and other equipment, utilize radio transmitters and receivers to transmit data signals from one device or node to another. These radio transmitters and receivers utilize a specific frequency band and protocol to accomplish this task.

Since these wireless networks and communications areas may overlap, standards, protocols, and privacy protection are necessary. One current standard in the industry has been established by the Institute of Electrical and Electronics Engineers, Inc. (IEEE) and is known as IEEE 802.11. This standard includes communications standards, protocol, and equipment specifications for wireless communication equipment. Included among these standards are provisions for privacy and encryption.

Another innovation in the wireless communications arena is the advent of short-range wireless networking between portable communications devices. One standard for this technology, commonly known as Bluetooth®, is being established by a collaborative group of communications and computing companies. Devices incorporating Bluetooth® technology typically utilize a microchip transceiver for communications between devices. Bluetooth® devices typically transmit in the 2.4 GHz range and have a range of about 10 meters, which may be extended to about 100 meters by increasing the transmitter power. Bluetooth® technology may prove to be a viable and economical networking solution for interconnecting cell phones, computers, printers, modems, computer peripherals, fax machines, and other communications and computing devices. The size of the Bluetooth® transceiver makes it usable in devices as small as palmtop computers and cell phones.

Another established wireless connectivity standard is known as IrDA and employs infrared radiation to communicate between devices. IrDA is a point-to-point narrow angle, ad-hoc data transmission standard designed to operate over a distance of 0 to 1 meters at speeds of 9600 bps to 16 Mbps. It is typically used in a point-and-shoot fashion by pointing one device at another for direct data transmission.

Despite the various technological advances in electronic communication and payment methods, the use of coupons to purchase goods and/or services remains a “low-tech” process. Coupons are typically printed on paper and distributed in hard copy form. The look and format of coupons is, for the most part, standardized. The typical coupon indicates the goods or services for which the discount coupon may be used and the amount of the discount that the coupon entitles the purchaser to receive. The product and figure may often be associated with a scannable UPC-type bar code on the coupon. The coupon also typically includes information about where and when the coupon may be used. Usually, coupons have an expiration date and may limit the number of products that may be purchased using the coupon or the vendor participation.

The issuer of the coupon may be the manufacturer or the vendor of a particular product. The issuer typically attempts to distribute copies of the coupon to consumers in order to entice customers to purchase. The issuer may use advertising media, such as newspapers or magazines to distribute the coupons, or may distribute them through vendors or local mailings. When a purchaser wishes to use the coupon, the purchaser typically cuts the coupon from the newspaper or magazine and retains the coupon until the product or service is purchased. At the time of purchase, the purchaser presents the coupon to the vendor, who scans the bar code and subtracts the discounted amount of the coupon from the purchase price. If the manufacturer issues the coupon, the vendor typically forwards the coupon information to the manufacturer for reimbursement. If the vendor issued the coupon, the vendor typically absorbs the loss of the product discount. If the purchaser fails to use the coupon before the expiration date, the coupon is invalid and cannot be used.

Clipping, storing, and redeeming coupons are time-intensive. To facilitate this process, Internet-based systems exist that allow a consumer to view a list of coupons organized by category on web page, print out a hard copy of any of the coupons so that the coupons may be scanned by a vendor when the corresponding product is purchased.

### SUMMARY OF THE INVENTION

The present invention relates to methods and systems for electronic coupon issuance transmission and management. In particular, the present invention relates to obtaining and/or utilizing an electronic coupon when purchasing a product and/or service in order to obtain the benefit of the electronic coupon and to the management of the electronic coupons utilized.

Implementation of the present invention takes place in association with one or more computer devices and sets of computer executable instructions that operate in conjunction with the one or more computer devices to transmit and receive the instructions in order to conveniently and electronically generate, issue, distribute, manage and redeem the electronic coupons.

In accordance with the present invention, an electronic coupon includes various types of information relevant to redemption, such as information identifying the discounted product, the amount of the discount, the expiration date, and any limitations on the use of the electronic coupon. The electronic coupons may further include other valuable information, such as the total purchase price of the product, the manufacturer identification, the vendor identification, the purchaser identification, the product description, the purchase date, the purchase time, the method of purchase, and/or any other additional information that may be beneficial, such as purchaser profile information, vendor profile information, authorization information, coupon management information, and/or other transactional information. One implementation of the present invention includes electronic coupons that store itemized information so that the electronic coupons may be automatically categorized.

One advantage of the present invention over traditional methods is that the present invention provides unique ways to offer discounts to the purchaser. Likewise, the electronic coupons of the present invention provide unique mechanisms for organizing the coupons as well as for tracking customer profiles and limitations on coupon usage. For example, the electronic coupons of the present invention allow for automatic adjustments in the amount of the discount given to the purchaser based upon the amount of product the purchaser is currently buying, or upon the amount the purchaser has bought in the past. The amount of the discount may also be adjusted for particular conditions, such as for promptness in redemption, the type of payment used (e.g., cash or credit), the frequency of purchases made, or for the purchase of other products made by a the same manufacturer or sold by the same vendor.

In addition to adjustments in the amount of the discount, some coupons of the present invention (or their associated applications) may be programmed so as to inform the purchaser of the electronic coupons that may be redeemed at a particular vendor location. For example, when a purchaser enters a vendor's establishment, a signal from the vendor's device to the purchaser's device may provide a list of the coupons that may be presently redeemed at that particular location. In addition, the coupons may be programmed to expire on a particular date or at a particular time, and to provide a reminder to the purchaser before their expiration with an alarm or message. Electronic coupons may also be programmed to “refresh” themselves periodically or to provide a standing discount if the coupon is used during a required period of time (e.g., once a month) or may be “prioritized” according to expiration dates.

In some implementations of the present invention, a vendor or manufacturer's device at a point of sale may issue the electronic coupons. When such distribution takes place, the electronic coupons may be transmitted from the manufacturer device to a purchaser device where the coupons may be stored for further processing within the device and for further transmission and redemption to other vendor devices and systems.

The issuer of the electronic coupons may distribute coupons over the Internet by providing them to potential purchasers from a particular web site. Alternatively, the issuer may distribute the electronic coupons to potential purchasers via e-mail or by stand-alone coupon distribution devices maintained at locations convenient to the potential purchasers. The coupons may be transmitted to a purchaser's storage device using a cable or docking connection or over a wireless network connection.

The electronic coupons are generally transmitted to or from a purchaser computer device. In one implementation, the purchaser computer device is a wireless purchasing device (WPD), that stores and manipulates the electronic coupon. A purchaser computer device may process and display the electronic coupon information directly as well as retransmit the coupon information to other devices or systems for further processing. A WPD may take a variety of forms, including a personal digital assistant (PDA), a wireless phone, or some other wireless communication device.

Implementations of the present invention may employ a vendor computer device, such as a wireless vendor device (WVD). The WVD may be a single device or a combination of devices capable of receiving and transmitting coupon information to and from the WPD through wireless communications technologies. One such implementation employs a radio frequency transmitter, an Infrared transmitter, or another wireless communication method to receive and/or transmit coupon information. For example, the vendor device compares the products being purchased, such as those electronically scanned into the register (or some other price calculating device), with the purchaser's available electronic coupons.

In one implementation, the electronic coupons are transferred from the WPD to a wireless point-of-sale vendor device over a wireless system such as a Bluetooth® or IrDA connection. In this implementation, no direct Internet connection may be required as the coupon information may be transferred directly over a wireless connection from the WPD to the vendor device.

In another implementation, it is possible to use an electronic coupon while purchasing an item over a direct Internet connection via an Internet Protocol, such as WAP, whereby the electronic coupon is transferred from the WPD to the vendor device or server via a wired or a wireless Internet connection.

In another implementation, it is possible for the WPD to provide a reference address to an electronic coupon stored in another electronic location on the Internet to the vendor device or server, whereby the vendor device or server gets the electronic coupon information and provides the WPD owner with a discount based upon the reference.

Once the electronic coupon information has been exchanged, the information derived from the electronic coupon may be processed and manipulated to provide additional functionality. For example, multiple electronic coupons may be analyzed or manipulated to provide a user with an accounting of each item purchased along with relevant coupon discount information. Information listed in electronic coupons may be categorized into categories of items for profiling and for future purchasing purposes. Each electronic coupon may be placed in one or more categories, and each coupon may be related to specific purchasing locations. Further implementations of the present invention provide for calendaring expiration dates as well as providing a corresponding reminder that allows a user to be constantly aware of coupon/discount availability. In one implementation, software modules for carrying out the various coupon-related functions are installed on all of the devices that are used to issue, distribute, and redeem the electronic coupons.

Thus, the present invention provides electronic coupons with a variety of automated features that are convenient for consumers to use and that provide coupon issuers with unprecedented flexibility, ease of distribution, and feedback. While the methods and processes of the present invention have proven to be particularly useful in the area of issuing, managing and using electronic coupons, those skilled in the art can appreciate that the methods and processes of the present invention may be used in a variety of different applications and in a variety of different areas of manufacture to yield desirable benefits and results to purchasers, vendors and/or manufacturers.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a representative system that provides a suitable operating environment for use of the present invention;

FIG. 2 illustrates a representative example of communication exchanges between various computer devices and/or systems in accordance with the present invention;

FIG. 3 illustrates a flow chart that provides a representative embodiment for utilizing one or more electronic coupons, where the coupons are analyzed prior to being provided to a vendor; and

FIG. 4 illustrates a flow chart that provides a representative embodiment for utilizing one or more electronic coupons, where the coupons are analyzed after being provided to a vendor.

### DETAILED DESCRIPTION OF THE INVENTION

The present invention relates to methods and systems for electronic coupon issuance transmission and management. In particular, the present invention relates to obtaining and/or utilizing an electronic coupon when purchasing a product and/or service in order to obtain the benefit of the electronic coupon and to the management of the electronic coupons utilized.

In the disclosure and in the claims the term “coupon” shall refer to any monetary rebate, non-monetary equivalent, or desirable benefit associated with a product or service that is offered to a purchaser by a vendor or manufacturer. Examples of coupons include gift-certificates, tickets, discount coupons, discounted admissions, or other means for representing a discounted value or other desirable benefit, including means that do not represent value in terms of government issued currency. A coupon may also include an affiliation or membership identification at an institution or with an organization, particularly where such affiliation affords a discount. A coupon may be an electronic data file, which contains information as described above, stored locally on the device and/or an electronically referenced location to an electronic data file stored on the Internet or other electronic location. Furthermore, in the disclosure and in the claims the term “transceive” shall refer to the ability to transmit and/or receive an electronic coupon in accordance with the present invention and refers to the transmission and/or reception of locally stored data files or references to data files stored in an electronic location.

Embodiments of the present invention take place in association with one or more computer devices and computer-executable instructions that operate in conjunction with the computer devices to transmit and receive the instructions in order to conveniently and electronically generate, issue, distribute, manage, and redeem the electronic coupons.

The following disclosure of the present invention is grouped into two subheadings, namely “Exemplary Operating Environment” and “Utilizing an Electronic Coupon.” Use of the subheadings is for convenience of the reader only and is not to be construed as limiting in any sense.

Exemplary Operating Environment

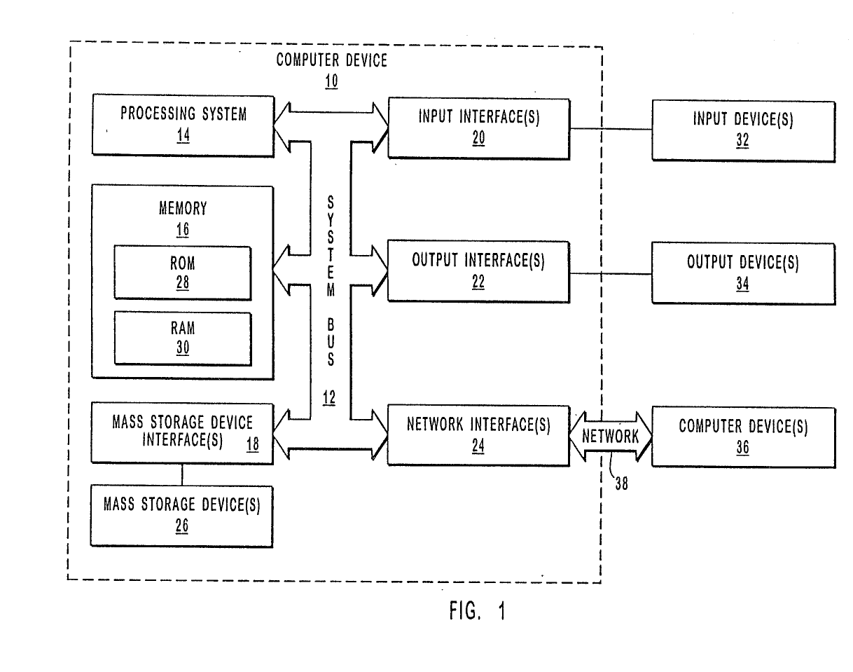

FIG. 1 and the corresponding discussion are intended to provide a general description of a suitable operating environment in which the invention may be implemented. One skilled in the art will appreciate that the invention may be practiced by one or more computing devices and in a variety of system configurations, including in a networked configuration, in order to provide and utilize one or more electronic coupons.

Embodiments of the present invention embrace one or more computer readable media, wherein each medium may be configured to include or includes thereon data or computer executable instructions for manipulating data relating to an electronic coupon. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing the invention include computer device 10, which may be a general-purpose or special-purpose computer that is configured to accept or otherwise utilize an electronic coupon in accordance with the present invention. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, such as data relating to an electronic coupon, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable data and/or instructions to be input into computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, an infrared port, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, an infrared port, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

Electronic Coupon Issuance and Usage

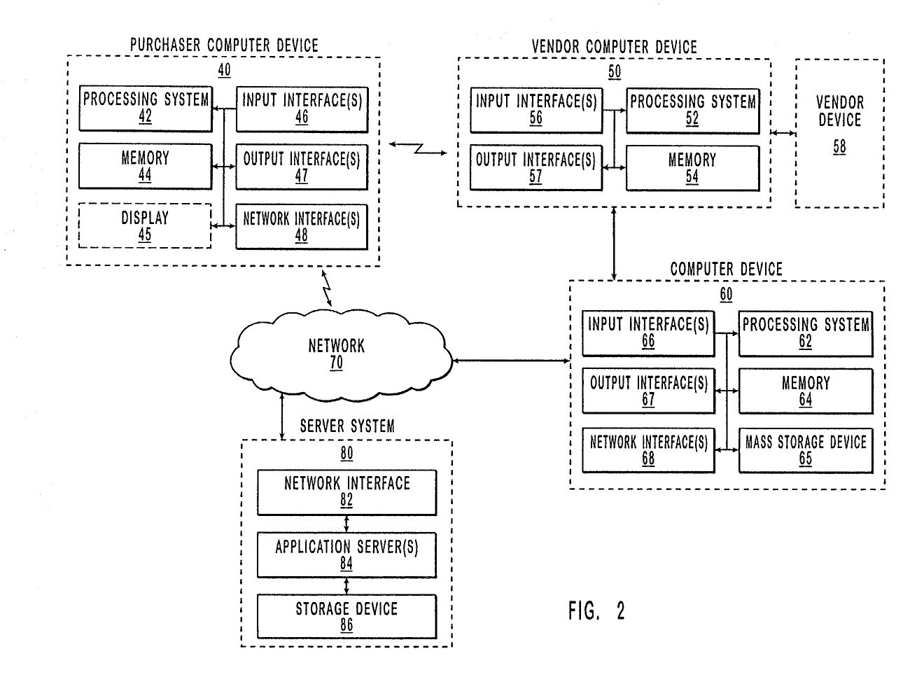

While those skilled in the art will appreciate that the invention may be practiced in networked computing environments with many types of computer system configurations, FIG. 2 represents an embodiment of the present invention in a networked environment that includes a variety of computer devices that are configured to exchange data across wireless and/or hardwired mediums. While FIG. 2 illustrates an embodiment that includes a purchaser computer device 40, a vendor computer device 50, a computer device 60, a network 70, and a server system 80, alternative embodiments include more or less computer devices in a variety of different configurations to communicate information relating to one or more electronic coupons.

In FIG. 2, an example of a wireless purchasing device (WPD) is illustrated as purchaser computer device 40, which includes processing system 42, memory 44, input interface(s) 46, output interface(s) 47, and network interface(s) 48. Processing system 42 may be used for processing consumer input, communications functions, and display functions as well as other functions. Purchaser computer device 40 may take the form of a personal digital assistant (PDA), a wireless phone, or other wireless communication device. Device 40 may also comprise a display 45, however display 45 is not required for all embodiments. Input interface 46 may be used to allow for consumer input and selection. Device 40 may exchange information with other electronic devices using output interface 47 and/or input interface 46, which may be electrically coupled to a communications device that incorporates long-range and/or short-range communication. Alternatively, information may be exchanged over a network, using network interface 48.

The communications device may be used, for example, to communicate with a manufacturer's or vendor's point-of-sale device, illustrated as vendor computer device 50, which may be a wireless vending device (WVD). Optionally, the communications device may be used to communicate with other WPDs, with an external communication device, or with other electronic devices such as computer device 60.

In one embodiment, an important function of device 40 is to communicate with device 50 and to transmit and receive electronic coupon information therefrom. An example of a communications device that uses short-range communications is a Bluetooth® transceiver or similar short-range networking device. Another example includes an Infrared transceiver, such as an IrDA standard port. Wireless means of communication may also include radio frequency transmitters. Device 40 comprises memory 44 for storing electronic coupons and other information relating to electronic coupons. An input or output device (not shown) coupled to input interface 46 and/or output interface 47 may be used to communicate with a vendor computer device at a point-of-sale transaction when wireless communication is not available or desired.

Some embodiments of device 40 may also comprise a biometric input device, coupled to input interface 46, which may be used to verify user identity. A biometric input device may use thumb print analysis, retinal scan analysis, or another identification method to identify the user. Once the user is identified, user identity may be matched to account data to ensure that unauthorized users do not gain access to sensitive information or to another user account.

In one embodiment of the present invention, device 50 is positioned at a point of sale for communication with device 40, and may be a single device or a combination of devices capable of receiving and transmitting coupon information to and from purchaser devices, such as device 40. Vendor computer device 50 includes a processing system 52, memory 54, input interface 56, and output interface 57. A communications device (not shown) may be electrically coupled to input interface 56 and/or output interface 57 to enable communication with device 40. The communications device may be, for example, a Bluetooth® transceiver, an IrDA port, or another communications device or short-range transceiver. A Bluetooth® transceiver or similar networking device may be particularly desirable in situations where multiple vendors are simultaneously accessible to a single wireless purchasing device to allow for multiple party communications. In one embodiment, the communications device used in association with the wireless vendor device provides for communication exchanged across a hardwired medium, such as via a cable, to the wireless purchasing device, illustrated as device 40.

Device 50 may include or otherwise be coupled to a vendor device 58, which is typically an electronic computing device, such as an electronic cash register, an electronic vending machine, a bar code reader, or other device, that may transmit and receive electronic coupon information as well as product and transaction information.

Some embodiments of the present invention also include a secondary computing, illustrated as computer device 60, which is configured to communicate with device 50 and/or device 40. Computer device 60 may include a processing system 62, memory 64, mass storage device 65, input interface 66, output interface 67, and a network interface 68. Furthermore, computer device 60 may be embodied in a variety of different forms including, but not limited to, a desktop computer, a mainframe computer, a storage device, a network server, an Internet site, and/or many other forms of computer devices.

Device 60 may be used for the storage and processing of electronic coupon information. For example, when device 40 has limited processing ability, limited display capability, limited memory, or other limiting features, device 60 may be useful for receiving information from device 40, either directly or through device 50, for the processing, display, storage, conversion, or other manipulation or use of electronic coupon information. Even when device 40 does not have limited features, information may be transmitted to device 60 for archival storage, redundant file maintenance, or for any other reason.

Computer device 60 may communicate with the device 40 via a short-range communication device, through device 50, or across a network, such as network 70. Device 60 may optionally communicate with device 40 through a direct hardwired link, such as a cable. Modems, network adapters, serial ports, parallel ports, USB ports, and/or any other communications adapters or connections may be used to facilitate communication from one computer device to another computer device within the system.

As shown in FIG. 2, an exchange of information 44 takes place between device 50 and device 40 during operation of the illustrated embodiment of the present invention. The information exchange includes the transmission of electronic coupons from vendor computer device 50 to purchaser computer device 40, or from purchaser computer device 40 to vendor computer device 50.

Information exchanged relating to an electronic coupon includes various types of data relevant to redeeming the coupon, including the discounted product, the amount of the discount, the expiration date, and limitations on use of the electronic coupon. Additionally, the information relating to the electronic coupon may include the total purchase price, a manufacturer identification, a vendor identification, a purchaser identification, an item or product description, itemized pricing, a purchase date, a purchase time, discount information, coupon management information, purchaser profile information, vendor profile information, and/or other transactional information. An electronic coupon may further include information that enables the automatic, detailed tracking of items purchased by a particular vendor and/or from a particular vendor. Automated logging or categorizing of stored coupons is also enabled in some embodiments of the present invention.

The electronic coupons of the present invention provide unique manners for offering discounts to a purchaser on a variety of bases, including based on the tracking of customer profiles. For example, some electronic coupons of the present invention allow for automatic adjustments in the amount of the discount given to the purchaser based upon the amount of product the purchaser is buying, or upon the amount the purchaser has bought in the past. The amount of the discount may be automatically adjusted for particular conditions, such as promptness in redemption, the type of payment used (e.g., cash or credit), the frequency of purchases made, or for purchases of other products made by the same manufacturer or sold by the same vendor.

In addition to adjustments in the amount of the discount, some coupons of the present invention (or their associated software applications) may be programmed to inform the purchaser of discounts that are available. For example, when a purchaser enters a vendor's establishment, a signal from a vendor computer device 50 to the purchaser computer device 40 may bring up a list of the coupons that are currently redeemable at that location. In addition, the coupons may be programmed to expire on a particular date or at a particular time, and to provide a reminder to the purchaser prior to their expiration. Electronic coupons may be programmed to “refresh” themselves periodically or to provide a standing discount if the coupon is used during a particular period of time, such as once a week, once a month, or once a year. The coupons may also be programmed to be “prioritized” according to expiration dates or to limit usage to a pre-defined number of times per purchaser.

In one embodiment of the present invention, a vendor computer device 50 or a manufacturer's computer device at the point of sale issues the electronic coupons. When distribution occurs, the electronic coupons may be transmitted from the vendor/manufacturer device to a purchaser computer device 40, where the coupons may be stored for further processing within the device 40, and for further transmission and redemption to other vendor devices and systems.

In one embodiment, software modules for carrying out the various coupon-related functions are installed in all the devices that are used to issue, distribute, and redeem the electronic coupons. The issuer of the electronic coupons distributes coupons over the Internet by providing them to potential purchasers from a centralized web site run by either the software issuer or the coupon issuer. This is illustrated in FIG. 2 by server system 80, which includes network interface 82, application server(s) 84, and storage device 86. Application server(s) may be used to maintain a web site, where data is store at storage device 86. Server system may be accessed through network 70, which may include wireless and/or hard-wired links, and may comprise a local area network (LAN) or a wide area network (WAN).

Alternatively, the software or coupon issuer may distribute the electronic coupons to potential purchasers via e-mail using a computer network or using stand-alone coupon distribution devices maintained at locations convenient to the potential purchasers. As will be discussed below, the coupons may be transmitted to a memory 44 using a cable or docking connection or over a wireless network connection.

In one embodiment of the present invention, a coupon is used while purchasing an item over a direct Internet connection via an Internet Protocol, such as WAP, whereby the coupon is transferred between device 40 and device 50 via a wired or a wireless Internet connection.

Once the electronic coupon information has been transmitted to device 50 or device 40, the information derived from the electronic coupon may be processed and manipulated to provide additional functionality. Some embodiments of the present invention employ processing methods that compile multiple electronic coupons and provide a user with an accounting of each item purchased along with relevant coupon discount information. Information listed in electronic coupons may be categorized for profiling and for future purchasing purposes. Each electronic coupon may be placed in one or more categories, and may be related to specific purchasing locations. Some embodiments provide for the calendaring of expiration dates as well as a corresponding alarm that allows a user to be constantly aware of coupon/discount availability.

The information exchanged between device 40 and device 50 may include multiple transactions and multiple bilateral or unilateral data transmissions. In one embodiment, information exchanged between device 40 and device 50 includes electronic coupon redemption information, the purchaser's prior coupon redemption history, and/or the purchaser's consumer purchasing profile. Information exchange 44 may also include verification of and/or information related to the identity of the purchaser, along with account information. Some or all of the information exchanged may be encrypted, coded, or otherwise manipulated to preserve privacy.

Information stored in device 40 may be compiled, displayed, converted, or otherwise manipulated within device 40 through the use of processing system 42, memory 44, and/or other components. In one embodiment, the device 40 displays a running total of coupon savings and/or display discount totals by category.

In one embodiment, a purchaser/user may transfer electronic coupon information from purchaser computer device 40 to a secondary computing device for further processing, storage, archiving, and/or other functions. Such transferring is useful in embodiments wherein device 40 has limited processing capabilities. The secondary computing device may be, for example, a home computer or other computer device, such as computer device 60, that transmits compiled coupon and purchasing information back to purchaser device 50 for display and reference.

In one embodiment, the purchaser or user transfers electronic coupon information to a server 84, such as a web server, for further processing, storage, archiving, and other functions. The transfer may take occur over a wireless connection. Server 86 may provide compiled coupon information, including a categorized itemization of electronic coupons, based on the purchaser's purchasing profile. In one embodiment, the server 84 may additionally provide account information, and may transmit information back to device 40 for display and reference while a user is unable to connect to computing device 60. The latter information may include compiled coupon and purchasing information.

In one embodiment, the server 84 may also serve as a wireless point of sale wherein the purchaser computer device 40 has wireless access to the server 84. Here, a web server may automatically redeem electronic coupons as well as synchronize and store the electronic coupon information.

In one embodiment, the server 84, vendor computer device 50, or computer device 60 may provide electronic coupons to the purchaser computer device 40 for use at a point of sale. In a further embodiment, server 84 may be used to beam electronic coupons to individual vendors so that the vendors may distribute the coupons to purchasers.

As previously mentioned, the electronic coupon information may include detailed information in an itemized format so that purchase data may be tracked, stored, and/or compiled. Conveniently, a single electronic coupon may be assigned to certain categories for which aggregate information may be compiled, such as an aggregate product or coupon use profile. A user may be alerted when coupons, which are related to the user's purchase profile, are available or are about to expire.

One embodiment of an electronic coupon further includes complete file integrity so that issuers and users may be assured of accurate coupon information regardless of the location or possession of the electronic coupon file. File integrity may be preserved through the independent transmission and storage of original coupon information by an independent verification service or by other data integrity preservation methods. In addition, further embodiments of the present invention include a mechanism that prevents the coupons from being copied without proper authorization.

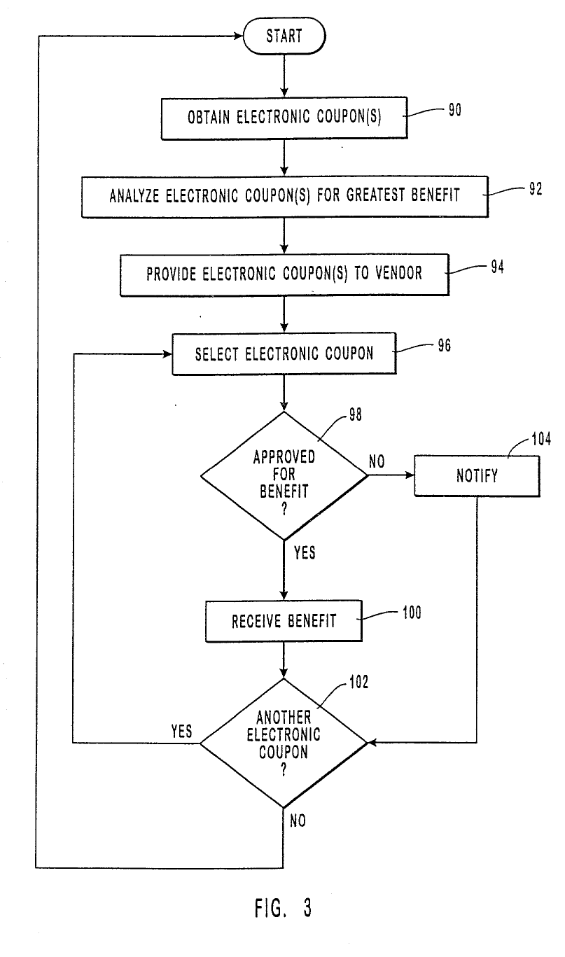

With reference now to FIG. 3, a flow chart is illustrated that provides a representative embodiment for utilizing one or more electronic coupons, where the coupons may be analyzed prior to being provided to a vendor. In FIG. 3, execution begins at step 90, where a user obtains one or more electronic coupons. The user may obtain the coupons in a variety of manners, including by subscribing to an electronic coupon service. The coupons may be obtained as they are made available or may be obtained according to preset parameters that increase the likelihood that the user would use the coupons. The electronic coupon service allows the user to view a list of available coupons and selectively or automatically download electronic coupons to the HCD. The list of coupons may be viewed through an Internet browser or as part of a coupon management program. The Internet browser or coupon management program may be viewed either on the purchaser computer device or on a secondary computing device that may be connected to the purchaser computer device. A server may provide the coupon service to the user.

In one embodiment, the purchaser may manually select the coupons that he/she wishes to download. The coupons are downloaded when the purchaser synchronizes his/her computer device with the coupon server. Optionally, each time the purchaser subsequently synchronizes his/her computer device to the electronic coupon service, the types of coupons previously selected for download from the server are automatically loaded onto the user's computer device from the coupon service. Additionally, related coupons may be newly offered for downloading, and coupons present on the user's computer device may be automatically updated.

Alternatively, a pre-selected category of electronic coupons, such as coupons representative of a given manufacturer, may be automatically downloaded to the user's computer device as the coupons become available from the coupon service. The selection of coupon type for automatic download may be based on the purchaser's profile, which may be stored on the coupon server or on the user's computer device.

With reference back to FIG. 3, once the user at step 90 obtains the electronic coupons, the various electronic coupons are analyzed for providing the greatest benefit to the user at step 92. For example, indicating the products or services that are to be purchased and the quantities may enable information processing to occur that recommends when, where, what or how a particular product is purchased, including the about of the product, to maximize the benefit for the user.

Execution then proceeds to step 92, where the electronic coupons are provided to the vendor. When the purchaser presents the coupons to a vendor for redemption, the purchaser may bring up the coupons on the purchaser's computer device. The coupons may appear, for example, on the screen with a UPC bar code or may be transferred to the vendor. If the purchaser and vendor are employing IrDA or Bluetooth® communication, or similar communication means for wireless transmission and reception, the vendor may receive the coupons at the check-out register through an electronic transmission means such as the Bluetooth® or Infrared device (as opposed to through scanning by use of a bar code reader).

At step 96, each electronic coupon presented is individually selected and validity is determined at decision block 98. Validity may be determined by the purchaser computer device comparing the products being purchased, such as those electronically scanned into the register (or some other price calculating device), with the purchaser's available electronic coupons, and by electronically reviewing any requirements for use of a particular coupon. If it is determined that the coupon use is approved, the user receives the benefit of the coupon at step 100. Otherwise, a notification is made that the coupon use is not approved at step 104. A determination is then made at decision block 102 as to whether or not another electronic coupon has been presented. If it is determined that another coupon was presented, that coupon also undergoes an approval process. This use of an approval process is a security mechanism that approves the discount upon verification of the coupons' authenticity or appropriate use. Furthermore, if a coupon is of the type designed for a one-time-only use, the coupon is then either marked as “used” or is deleted from the user's computer device.

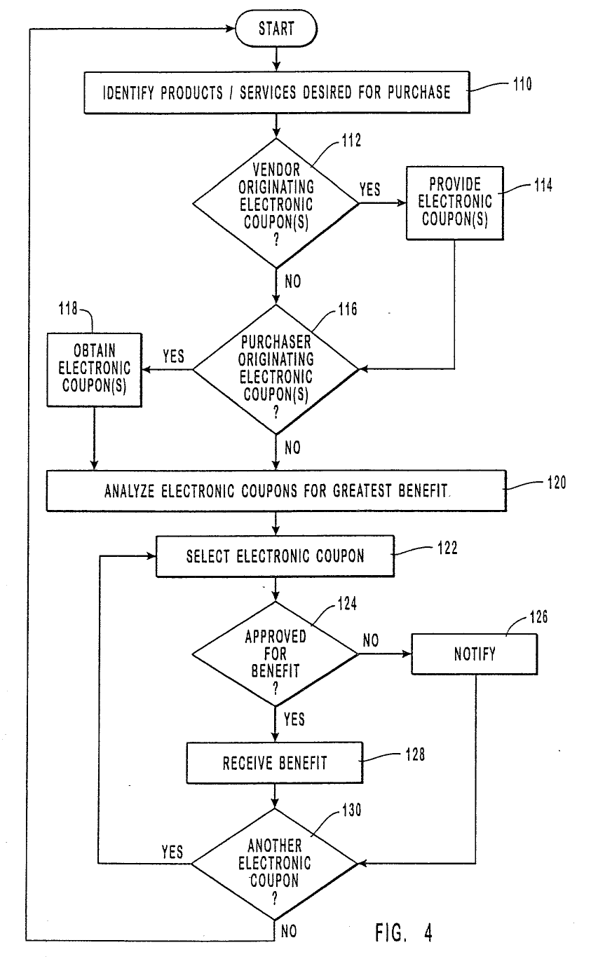

With reference now to FIG. 4, a flow chart is illustrated that provides a representative embodiment for utilizing one or more electronic coupons, where the coupons may be analyzed after being provided to a vendor. In FIG. 4, execution begins at step 110, wherein the products and/or services desired for purchase are identified, such as by scanning or by other means indicated above. The vendor computer device may be located at the point of sale wherein the purchaser pays for the items.

A determination is made at decision block 112 as to whether or not the vendor has access to any applicable coupons that may be used in the purchase transaction. If so, the vendor device provides the applicable electronic coupons at the point of sale at step 114. A determination is then made at decision block 116 as to whether or not the purchaser has access to any applicable coupons that may be used in the purchase transaction. If so, the purchaser device provides the applicable electronic coupons at the point of sale at step 118.

At step 120, the available electronic coupons are analyzed to provide the greatest benefit to the purchaser. Each coupon that may to be used in the transaction may be individually selected at step 122 and the approval for use is determined at decision block 124. If the coupon use is not approved, a notification is made at step 126, otherwise the purchaser may receive the benefit of the coupon at step 128. Execution then proceeds to decision block 130 for the determination if another electronic coupon was presented for the transaction to allow each coupon to undergo an approval process.

In accordance with the present invention, the vendor's computer device may be used to tracks the upload and usage rate of each coupon, the impact of their campaigns, the dispersal patterns of their coupons, the redemption demographics of the users of the coupons, the general demographics of each customer who downloads and uses them, and the like. Similarly, the vendor computer device may provide an electronic report to another computer device, such as a manufacture's computer device, to enable similar tracking of information. The tracking provides for specific feedback on the coverage and impact of the various coupons.

Thus, as discussed herein, the embodiments of the present invention embrace methods and systems for electronic coupon issuance transmission and management. In particular, the present invention relates to obtaining and/or utilizing one or more electronic coupons when purchasing a product and/or service in order to obtain the benefit of the electronic coupon and to the management of the electronic coupons utilized.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A system for utilizing an electronic coupon, the system comprising:
a vendor computer device configured to utilize the electronic coupon to provide a benefit;
a purchaser computer device configured to communicate with the vendor computer device at a point of sale; and
a short-range communications device coupled to the purchaser computer device to enable the communication with the vendor computer device at the point of sale.

2. A system as recited in claim 1, further comprising a biometric input device coupled to the purchaser computer device for positive identification of a user.

3. A system as recited in claim 1, further comprising a secondary computer device configured to transceive the electronic coupon.

4. A system as recited in claim 1, wherein said secondary computing device is at least one of:
(i) a server; and
(ii) a personal computer.

5. A system as recited in claim 1, wherein the purchaser computer device comprises at least one of:
(i) a cell phone; and
(ii) a personal digital assistant.

6. A system as recited in claim 1, wherein the communications device employs wireless communication.

7. A system as recited in claim 1, wherein at least one of (i) the vendor computer device and (ii) the purchaser computer device is configured to manage the electronic coupon.

8. In a system that includes a purchaser computer device, a vendor computer device, and an electronic coupon, a method for utilizing the electronic coupon, the method comprising the steps for:
providing the electronic coupon;
determining the validity of using the electronic coupon;
if the electronic coupon is determined to be valid for use, providing a benefit to a user.

9. A method as recited in claim 8, wherein the electronic coupon is provided from the purchaser computer device to the vendor computer device.

10. A method as recited in claim 9, wherein the step for providing comprises at least one of the steps for:
(i) scanning the electronic coupon;
(ii) transmitting the electronic coupon via a wireless communication connection; and
(iii) transmitting the electronic coupon via a hard-wired communication connection.

11. A method as recited in claim 8, wherein the step for determining comprises the step for verifying the identity of the user.

12. A method as recited in claim 11, wherein a biometric input device is used in performing the step for verifying.

13. A method as recited in claim 8, wherein the electronic coupon is provided from a secondary computer device.

14. A method as recited in claim 8, further comprising the steps for:
determining the validity of using a second electronic coupon;
comparing the electronic coupon with the second electronic coupon to determine which electronic coupon is preferred, wherein the benefit provided to the user corresponds to the preferred electronic coupon.

15. A method as recited in claim 14, wherein the step for comparing includes at least one of the steps for:
(i) examining an expiration date; and
(ii) determining which provides a greater benefit;

16. A method as recited in claim 15, wherein the greater benefit is determined based on at least one of:
(i) promptness in redemption;
(ii) frequency of purchase;
(iii) type of payment employed;
(iv) one or more products presented for purchase;
(v) one or more manufacturers of products presented for purchase; and
(vi) one or more vendors of products presented for purchase.

17. In a system that includes a first electronic coupon, a first computer device that provides the first electronic coupon, and a second computer device that receives the first electronic coupon, a method for distributing the first electronic coupon, the method comprising the steps for:
providing the first electronic coupon at the first computer device;
selectively transmitting the first electronic coupon from the first computer device to the second computer device to enable a benefit to be provided to a user of the second computer device.

18. A method as recited in claim 17, wherein the step for providing the first electronic coupon comprises the steps for populating a database on said server with a plurality of downloadable electronic coupons, wherein the first electronic coupon is one of the plurality of downloadable electronic coupons.

19. A method as recited in claim 18, wherein the step for selectively transmitting comprises the steps for:
providing access to the database;
receiving a request for downloading the first coupon from the data base; and
downloading the first electronic coupon to in response to the request.

20. A method as recited in claim 19, wherein the request is initiated automatically based on preset criteria.

21. A method as recited in claim 19, wherein the request is selectively initiated by at least one of:
(i) the user;
(ii) a vendor;
(iii) a manufacturer of a product; and
(iv) a provider of a service.

22. A method as recited in claim 19, wherein the step for downloading is performed across the Internet.

23. A method as recited in claim 17, wherein the step for selectively transmitting is performed across a wireless communication.

24. A method as recited in claim 17, wherein the first electronic coupon is an electronic data file stored locally on the second computer device.

25. A method as recited in claim 17, wherein the first electronic coupon is an electronic reference location on a network that references the first computer device to a location where the electronic coupon is stored.

26. A computer program product for implementing within a computer system a method for utilizing an electronic coupon, the computer program product comprising:
computer readable medium for providing computer program code means utilized to implement the method, wherein the computer program code means is comprised of executable code for implementing the steps for:
providing the electronic coupon;
determining the validity of using the electronic coupon;
if the electronic coupon is determined to be valid for use, providing a benefit to a user.

27. The computer program product as recited in claim 26, further comprising computer program code means comprised of executable code for implementing the step for tracking information.

28. The computer program product as recited in claim 26, further comprising computer program code means comprised of executable code for implementing the step for providing a notification relating to the electronic coupon.

29. A computer program product for implementing within a computer system a method for distributing the electronic coupon, the computer program product comprising:
computer readable medium for providing computer program code means utilized to implement the method, wherein the computer program code means is comprised of executable code for implementing the steps for:
providing the electronic coupon at a first computer device;
selectively transmitting the electronic coupon from the first computer device to a second computer device to enable a benefit to be provided to a user of the second computer device.
